(19) United States
(12) Patent Application Publication
(10) Pub. No.: US 2005/0007585 A1
(43) Pub. Date: Jan. 13, 2005

(54) Flame atomic absorption spectrophotometer

(75) Inventor: Koki Yamamoto, Kyoto-fu (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Shimadzu Corporation, Kyoto (JP)

(21) Appl. No.: 10/875,216

(22) Filed: Jun. 25, 2004

(30) Foreign Application Priority Data
Jul. 11, 2003 (JP) 2003-196109(P)

(51) Int. Cl. G01J 3/30

(52) U.S. Cl. 356/315

(57) ABSTRACT

A flame atomic absorption spectrophotometer of the present invention includes: a gas selector for selecting the fuel gas from a plurality of reserve fuel gases and/or the assist gas from a plurality of reserve assist gases; a fuel gas flow controller for changing the flow rate of the fuel gas; an assist gas flow controller for changing the flow rate of the assist gas; a memory for storing data of an optimal flow rate of the fuel gas and an optimal flow rate of the assist gas for stabilizing the flame in a period spanning the time when the fuel gas and/or the assist gas is changed by the gas selector, where the data is prepared for every possible changing combination of the reserve fuel gas and the reserve assist gas; and a controller for changing the flow rate of the fuel gas and the flow rate of the assist gas according to data read out from the memory corresponding to the changing combination of the fuel gas and the assist gas before the fuel gas and/or the assist gas is changed by the gas selector, and for further changing the flow rate of the fuel gas and the flow rate of the assist gas to optimize the analysis using the flame after the fuel gas and/or the assist gas is changed by the gas selector.

The present invention relates to a flame atomic absorption spectrophotometer in which a mist of liquid sample is cast into a flame to atomize the sample.

### BACKGROUND OF THE INVENTION

In flame atomic absorption spectrophotometers, fuel gas and assist gas are separately provided to a chamber, and the mixed gas is ejected from a slit mouth of a burner and is burned to produce a flame. The sample liquid is sprayed, for example, in the flame to be atomized.

An appropriate fuel gas and an appropriate assist gas, and their flow rates depend on the object element to be analyzed. Acetylene gas is most widely used for the fuel gas, and propane gas and hydrogen gas are sometimes used. Air is mostly used for the assist gas, but dinitrogen monoxide is useful when such elements as aluminum or titanium that form strong oxides in a flame is to be analyzed, because it can produce a strong reducing flame of a higher temperature. When, therefore, two or more samples containing different elements are successively analyzed, the fuel gas and/or the assist gas should be changed between samples.

It is known that the flow rate of the fuel gas should be minimized in order to enhance the detecting sensitivity of an object element. But the combustion becomes less stable when the fuel gas flow rate is reduced. When, in that case, an assist gas is changed to another assist gas, the combustion becomes further unstable, and the flame may be extinguished or a backfire (where the combustion goes back into the mouth of the burner) may occur.

The Japanese Patent Application Unexamined Publication No. 2001-141649 discloses a flame atomic absorption spectrophotometer in which the fuel gas flow rate is increased to the level of stable combustion just before the assist gas is changed, and the fuel gas flow rate is then reduced to the level adequate to the analysis after the flame becomes stable.

### SUMMARY OF THE INVENTION

In the above flame atomic absorption spectrophotometer, the flow rate of the assist gas is supposed to be constant (exactly saying, the flow rate changes depending on the kind of gas because the flow rate depends on the viscosity of the gas even when the pressures at the entrance and at the exit are the same). In some flame atomic absorption spectrophotometers, the fuel gas flow rate and the assist gas flow rate are automatically controlled with valves disposed on the gas flow pipes. Normally in that case, the fuel gas flow rate and the assist gas flow rate are respectively set to the optimal values for the object analysis. Thus, if solely the fuel gas flow rate is controlled when the assist gas is changed, the combustion may become unstable and a fire extinction or backfire may occur depending on the set assist gas flow rate just after the assist gas is changed.

An object of the present invention is to provide a flame atomic absorption spectrophotometer in which the fuel gas flow rate and the assist gas flow rate are automatically set in normal times, and, when the fuel gas or the assist gas is changed, the combustion is maintained stable without causing a fire extinction or a backfire before and after the fuel gas or the assist gas is changed.

According to the present invention, a flame atomic absorption spectrophotometer for producing a flame using a fuel gas and an assist gas includes:

a gas selector for selecting the fuel gas from a plurality of reserve fuel gases and/or the assist gas from a plurality of reserve assist gases;

a fuel gas flow controller for changing the flow rate of the fuel gas;

an assist gas flow controller for changing the flow rate of the assist gas;

a memory for storing data of an optimal flow rate of the fuel gas and an optimal flow rate of the assist gas for stabilizing the flame in a period spanning the time when the fuel gas and/or the assist gas is changed by the gas selector, where the data is prepared for every possible changing combination of the reserve fuel gas and the reserve assist gas; and

a controller for changing the flow rate of the fuel gas and the flow rate of the assist gas according to data read out from the memory corresponding to the changing combination of the fuel gas and the assist gas before the fuel gas and/or the assist gas is changed by the gas selector, and for further changing the flow rate of the fuel gas and the flow rate of the assist gas to optimize the analysis using the flame after the fuel gas and/or the assist gas is changed by the gas selector.

In the a flame atomic absorption spectrophotometer of the present invention, the values of the flow rate of the fuel gas and the flow rate of the assist gas for stabilizing the combustion or the flame when a combination of the fuel gas and the assist gas is changed to another combination are obtained beforehand through experiments. The data of such values for every possible case of the combination changes are stored in the memory.

In most cases, the flow rate of the fuel gas or the flow rate of the assist gas is controlled by the opening ratio of the flow control valve disposed on the pipe for flowing the gas. In that case, the fuel gas flow controller or the assist gas flow controller adjusts the opening ratio of respective flow control valve. Generally, the flow rates of two gases are not the same even if the opening ratio of the flow control valve is the same. Thus, for example, the combination of optimal flow rates of the fuel gas and the assist gas for stabilizing the combustion when assist gas A is changed to assist gas B is different from the combination of optimal flow rates when assist gas B is changed to assist gas A.

When the assist gas is changed from gas A to gas B while the fuel gas is not changed, the controller reads out data from the memory corresponding to the change of the combination of the fuel gas and assist gas A to the combination of the same fuel gas and assist gas B, where the data represents optimal flow rates of the fuel gas and the assist gas for stabilizing the combustion. In the above-described case where the flow rate is controlled by the opening ratio of the flow control valve, the data represents the opening ratio of the fuel and the assist flow control valves. After the flow rates or the opening ratios are changed, the assist gas is changed to a new one. When the opening ratio of the flow control valve is changed, it is necessary to consider the time needed for the gas flow rate to actually change after the opening ratio of the flow control valve is changed. After a preset time period since the assist gas is changed, the fuel gas flow rate and assist gas flow rate are further changed to values optimal to the analysis using the fuel gas and the assist gas B.

According to the flame atomic absorption spectrophotometer of the present invention, the combustion in the burner is maintained stable in the period spanning the change of the assist gas or the fuel gas, and no fire extinction nor backfire occurs, which assures safety of the analysis. This effect is obtained irrespective of the combination of the fuel gas and the assist gas.

### BRIEF DESCRIPTION OF THE DRAWINGS

FIG. 1 is a schematic diagram of a flame atomic absorption spectrophotometer embodying the present invention.

FIG. 2 is a flowchart of the process of changing the assist gas in the flame atomic absorption spectrophotometer of the embodiment.

### DETAILED DESCRIPTION OF A PREFERRED EMBODIMENT

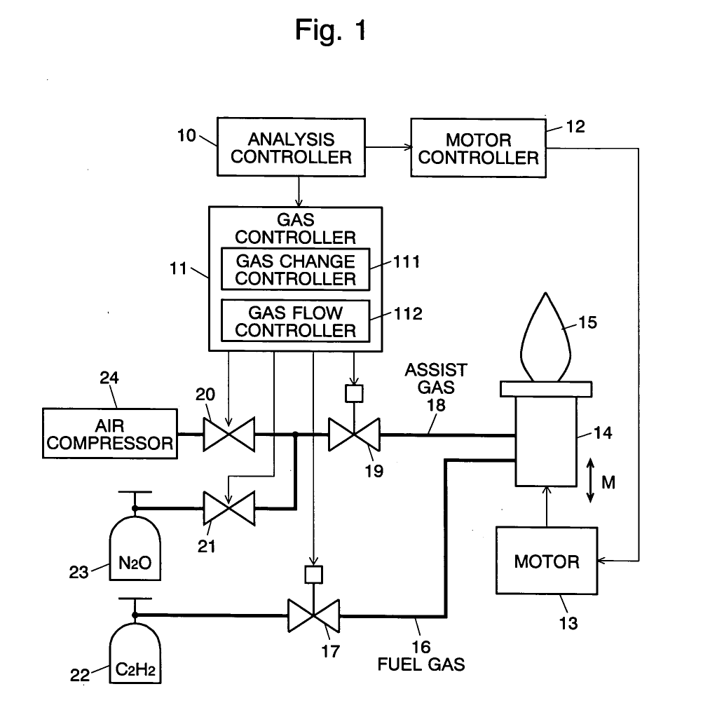

A flame atomic absorption spectrophotometer embodying the present invention is described referring to the attached drawings. As shown in FIG. 1, the burner 14 for producing a flame 15 is movable vertically (as shown by the arrow M) by the motor 13, which is controlled by the motor controller 12.

Acetylene (C₂H₂) gas is used for the fuel gas, which is contained in the fuel gas container 22. On the fuel gas pipe 16 connecting the fuel gas container 22 and the burner 14 is disposed a first flow control valve 17.

In the present embodiment, dinitrogen monoxide (N₂O) gas and air are used for the assist gas. Dinitrogen monoxide gas is contained in an N₂O gas container 23, and air is supplied by an air compressor 24. The pipe from the air compressor 24 and the pipe from the N₂O gas container 23 are merged to an assist gas pipe 18 connected to the burner 14. A first electromagnetic valve 20 is disposed on the air pipe, a second electromagnetic valve 21 is on the N₂O pipe, and a second gas flow control valve 19 is on the assist gas pipe 18.

The flame atomic absorption spectrophotometer of the present embodiment is equipped with an analysis controller 10 which includes a memory storing control programs for performing various analyses and various parameter values used in the analyses. The analysis controller 10 controls a gas controller 11 and the motor controller 12 according to the programs. The gas controller 11 functionally includes a gas change controller 111 and a gas flow controller 112, where the gas change controller 111 controls open and close of the electromagnetic valves 20 and 21, and the gas flow controller 112 controls the opening ratio of the flow control valves 17 and 19, or the flow rate of the fuel gas and the assist gas supplied to the burner 14. The gas flow controller 112 includes a memory storing values of the opening ratio necessary to stabilize the combustion when the assist gas (and the fuel gas) is changed.

In the present embodiment, solely acetylene gas is used for the fuel gas, and two kinds of gases, air and dinitrogen monoxide, are used for the assist gas. Thus the combination of [fuel gas/assist gas] is either [air/acetylene] or [dinitrogen monoxide/acetylene]. It is possible, however, to connect other gas container instead of the N₂O container 23 or the air compressor 24.

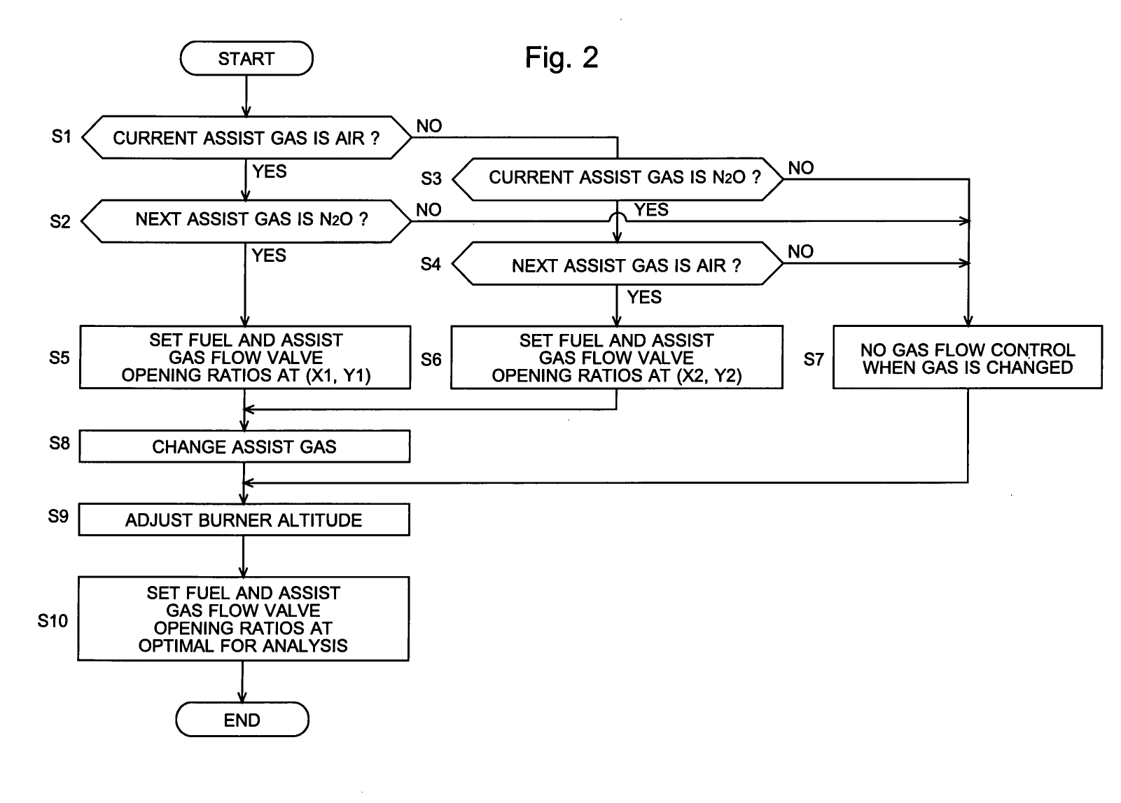

The control of the gas flows at the time when the assist gas is changed from air to dinitrogen monoxide, or from dinitrogen monoxide to air, is characteristic in the flame atomic absorption spectrophotometer of the present embodiment, which prevents a fire extinction or a backfire usually associated with conventional flame atomic absorption spectrophotometers. The process of the control is described referring to FIG. 2.

The analysis controller 10 performs a series of analyses according to a program selected by an analyzing operator. When, in the course of performing the program, it becomes necessary to change the assist gas, the analysis controller 10 determines whether the currently-used assist gas is air or not (Step S1). If the result is yes, it is then determined whether the assist gas to be used in the next analysis is dinitrogen monoxide or not (Step S2). When the result is again yes, or it is determined that the change of the assist gas is from air to dinitrogen monoxide, the analysis controller 10 reads out data corresponding to the case from its memory. The data includes the values (X1, Y1) of the opening ratio of the first and second flow control valves 17 and 19, and the analysis controller 10 sets the opening ratio of respective flow control valves 17 and 19 at the values (X1, Y1) (Step S5).

When the determination result at Step S1 is no, it is determined whether the currently used assist gas is dinitrogen monoxide or not (Step S3). When the result is yes, then it is determined whether the assist gas to be used in the next analysis is air or not (Step S4). If the result is yes, or it is determined that the change of the assist gas is from dinitrogen monoxide to air, the analysis controller 10 reads out data corresponding to the case from its memory. The data includes the values (X2, Y2) of the opening ratio of the first and second flow control valves 17 and 19, and the analysis controller 10 sets the opening ratio of respective flow control valves 17 and 19 at the values (X2, Y2) (Step S6).

When it is determined no at Step S2, Step S3 or Step S4, the assist gas will not be changed, or the assist gas needs to be changed to another kind of gas which is not supposed here. In these cases, no appropriate gas flow control is performed (Step S7).

The values (X1, Y1) of the opening ratio of the flow control valves 17 and 19 was determined beforehand through experiments to assure stabilized combustion in the period spanning the time when the combination of the gas is changed from [acetylene, air] to [acetylene, dinitrogen monoxide]. The values (X2, Y2) of the opening ratio of the flow control valves 17 and 19 was determined beforehand through experiments to assure stabilized combustion in the period spanning the time when the combination of the gas is changed from [acetylene, dinitrogen monoxide] to [acetylene, air]. The gas flow controller 11 changes the opening ratio of the flow control valves 17 and 19 according to the values, and a predetermined period after the change of the opening ratio, the gas change controller 111 drives both the electromagnetic valves 20 and 21 to change the assist gas (Step S8). Precisely saying, in changing the assist gas, it is preferable to hold both the electromagnetic valves 20 and 21 open temporarily to prevent neither assist gas is supplied to the burner 14.

When the altitude of the burner 14 needs to be adjusted after the assist gas is changed, the motor controller 12 drives the motor 13 to vertically move the burner 14 (Step S9). Then the opening ratio of the flow control valves 17 and 19 are respectively changed to the proper values to optimize the analysis (Step S10).

Thus in the flame atomic absorption spectrophotometer of the present embodiment a fire extinction or a backfire is prevented when the assist gas is changed, and the gas flows are adjusted to their optimized values for the analysis after that.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention. For example, other kinds of assist gas can be used instead of air and N₂O used above, and the present invention is applicable to the case where the fuel gas is changed, instead of the assist gas as described above.

1. A flame atomic absorption spectrophotometer for producing a flame using a fuel gas and an assist gas comprising:
a gas selector for selecting the fuel gas from a plurality of reserve fuel gases and/or the assist gas from a plurality of reserve assist gases;
a fuel gas flow controller for changing a flow rate of the fuel gas;
an assist gas flow controller for changing a flow rate of the assist gas;
a memory for storing data of an optimal flow rate of the fuel gas and an optimal flow rate of the assist gas for stabilizing the flame in a period spanning a time when the fuel gas and/or the assist gas is changed by the gas selector for every possible changing combination of the reserve fuel gas and the reserve assist gas; and
a controller for changing the flow rate of the fuel gas and the flow rate of the assist gas according to data read out from the memory corresponding to the changing combination of the fuel gas and the assist gas before the fuel gas and/or the assist gas is changed by the gas selector, and for further changing the flow rate of the fuel gas and the flow rate of the assist gas to optimize the analysis using the flame after the fuel gas and/or the assist gas is changed by the gas selector.

2. The flame atomic absorption spectrophotometer according to claim 1, wherein the fuel gas flow controller controls the flow rate of the fuel gas by changing an opening ratio of a fuel gas flow control valve disposed on a fuel gas pipe, the assist gas flow controller controls the flow rate of the assist gas by changing an opening ratio of an assist gas flow control valve disposed on an assist gas pipe, and the memory stores data of the optimal flow rate of the fuel gas and the optimal flow rate of the assist gas by values of the opening ratio of the fuel gas flow control valve and the assist gas flow control valve.

3. A method of controlling a flow of a fuel gas and a flow of an assist gas to a burner producing a flame of a flame atomic absorption spectrophotometer, the method comprising steps of:
determining through experiments an optimal flow rate of the fuel gas and an optimal flow rate of the assist gas for stabilizing the flame in a period spanning a time when the fuel gas and/or the assist gas is changed for every possible changing combination of the fuel gas and the assist gas;
storing data of the optimal flow rate of the fuel gas and the optimal flow rate of the assist for every possible changing combination of the fuel gas and the assist gas in a memory;
changing the flow rate of the fuel gas and the flow rate of the assist gas according to data read out from the memory corresponding to the changing combination of the fuel gas and assist gas before the fuel gas and/or the assist gas is changed; and
further changing the flow rate of the fuel gas and the flow rate of the assist gas to optimize the analysis using the flame after the fuel gas and/or the assist gas is changed.

4. The gas flow control method for a flame atomic absorption spectrophotometer according to claim 1, wherein the flow rate of the fuel gas is controlled by changing an opening ratio of a fuel gas flow control valve disposed on a fuel gas pipe, the flow rate of the assist gas is controlled by changing an opening ratio of an assist gas flow control valve disposed on an assist gas pipe, the memory stores data of the optimal flow rate of the fuel gas and the optimal flow rate of the assist gas by values of the opening ratio of the fuel gas flow control valve and the assist gas flow control valve.
